(19) United States
(12) Patent Application Publication
(10) Pub. No.: US 2026/0115601 A1
(43) Pub. Date: Apr. 30, 2026

(54) SERVER APPARATUS, INFORMATION PROCESSING APPARATUS, AND METHOD FOR PROVIDING INFORMATION

(71) Applicant: Sony Interactive Entertainment Inc., Tokyo (JP)

(72) Inventor: Takayuki Ochi, Kanagawa (JP)

(73) Assignee: Sony Interactive Entertainment Inc., Tokyo (JP)

(21) Appl. No.: 19/386,666

(22) Filed: Nov. 12, 2025

Related U.S. Application Data
(63) Continuation of application No. PCT/JP2023/022223, filed on Jun. 15, 2023.

(51) Int. Cl. A63F 13/79; A63F 13/35

(52) U.S. Cl. CPC A63F 13/79; A63F 13/35

(57) ABSTRACT

Server apparatus, information processing apparatus, and method for providing information are disclosed. An example server apparatus includes one or more processors that acquire play data of a user playing a game and generate information about game completion of the user from the play data of the user based on a completion pattern indicating an order of multiple play units to be performed by the game completion.

### CROSS-REFERENCES TO RELATED APPLICATIONS

This application is a Continuation application under 35 U.S.C. § 111 of International Application No. PCT/JP2023/022223, filed Jun. 15, 2023, the entire disclosure of which is incorporated herein by reference for all purposes.

### TECHNICAL FIELD

The present disclosure relates to art for providing information about a game to a user.

### BACKGROUND

For example, JP2022-63756A discloses a server apparatus that processes event data related to an activity performed by multiple players. The server apparatus acquires a play time of the activity by multiple players, assigns a player to any of multiple classes according to a skill value of the player, and determines a representative value of play time for each class based on the play time of multiple players in each class. The server apparatus notifies a user of an estimated play time derived from the representative value of the play time associated with the class of the user.

In another example, JP 2022-57395 discloses a server apparatus that supports users in procuring trophies, which are virtual prizes. This server apparatus extracts a relationship between an order in which trophies are procured based on an order in which multiple players have procured multiple trophies, references this relationship, and notifies the user of information about a trophy that the user may procure next.

### SUMMARY

By collecting data (play data) from multiple players playing a game, it becomes possible to derive various information through statistical processing and present such to the user. Therefore, an object of the present disclosure is to provide art for analyzing past play data of multiple players and presenting useful information to a user currently playing.

A server apparatus according to an aspect of the present disclosure is provided with one or more processors having hardware. The one or more processors acquire play data of a user playing a game, generate information about game completion of the user from the play data of the user based on a completion pattern indicating an order of multiple play units to be performed by the game completion, and provide the user with the information about the game completion.

A server apparatus according to another aspect of the present disclosure includes a recording apparatus that records past play data of multiple players, and one or more processors having hardware. The one or more processors analyze the past play data of the multiple players to derive a completion pattern indicating an order of multiple play units to be performed by the game completion.

An information processing apparatus according to another aspect of the present disclosure is further provided with one or more processors having hardware. The one or more processors acquire information about game completion generated based on a completion pattern indicating an order of multiple play units to be performed by the game completion and display an estimated time until the game is completed.

The method for providing information according to yet another aspect of the present disclosure acquires play data of a user playing a game, generates information about game completion of the user from the play data of the user based on a completion pattern indicating an order of multiple play units to be performed by the game completion and provides the user with the information about the game completion.

Note that any combination of the above constituent elements, and conversion of an expression of the present invention into a method, apparatus, system, computer program, data structure, recording medium, or the like, are also valid aspects of the present invention.

### BRIEF DESCRIPTION OF DRAWINGS

FIG. 1 is a diagram illustrating an information processing system according to an embodiment.

FIG. 2 is a diagram illustrating a hardware configuration of an information processing apparatus.

FIG. 3 is a diagram illustrating functional blocks of the information processing apparatus.

FIG. 4 is a diagram illustrating functional blocks of a server apparatus.

FIG. 5 is a diagram for describing a method for calculating a play time.

FIG. 6 is a diagram illustrating an example of a completion pattern of a game.

FIG. 7 is a diagram illustrating an example of a displayed system screen.

### DETAILED DESCRIPTION

An outline of the present disclosure will be described. In an embodiment, an information processing apparatus, which is a user terminal apparatus, executes game software. When an event occurs within a game, the game software outputs event information identifying the event that has occurred to system software. An event occurs when there is a change in progress of gameplay, a change in behavior of a game character, or the like. The game software includes multiple play units, each having at least an end condition.

As one type of play unit, the game software includes an activity that has a start condition and an end condition. The activity may be configured from a stage, a quest, a mission, a tournament, a session, or the like. The activity is set appropriately by a game maker, and for example, one quest that appears in the course of the game may constitute one activity, or multiple quests may constitute one activity. When multiple quests constitute one activity, conclusion of all of multiple quests is the end condition of the activity.

A game maker may set all of the stages, quests, missions, tournaments, and sessions incorporated into a game as activities, or may set only some of the stages, quests, missions, tournaments, and sessions as activities. As described above, one activity may be set for a combination of multiple quests or missions, forming one unit of play.

When starting an activity, the game software outputs to the system software an activity identifier (activity ID) that identifies the activity, and event information including information indicating the start of the activity. When ending the activity, the game software outputs to the system software the activity ID and event information including information indicating the end of the activity. At the end of the activity, the game software may include in the event information the results (success or failure) of the activity. The system software generates event data wherein a user identifier (user account) that identifies the user, a game identifier (game ID) that identifies the game, and time information (timestamp) are added to the event information output from the game software, and transmits this to an external server apparatus.

The server apparatus collects event data transmitted from multiple the information processing apparatus operated by multiple players and analyzes a play trend relating to the activity. For example, the server apparatus may statistically derive the play time of the activity performed by multiple players based on the event data transmitted from multiple information processing apparatuses. Furthermore, the server apparatus may statistically derive the order in which multiple activities are to be performed within one game, based on event data transmitted from multiple information processing apparatuses. For example, in games where a story progresses according to a scenario, such as role-playing games (RPGs), a number of activities tend to be performed in a predetermined order. Therefore, the server apparatus can analyze the event data of multiple players to identify the order in which multiple activities will be performed.

The game software sets various quests and missions (hereinafter simply referred to as “missions”) for procuring trophies, which are virtual rewards, as units of play separate from activities. When the user completes a mission, the user is awarded a trophy corresponding to the mission. The end condition of the mission is a play condition that releases the trophy to the user, and is also called an “unlock condition” of the trophy. An end determination of the trophy mission is made by the system software determining whether the unlock condition for the trophy has been achieved based on the event information output by the game software. The system software transmits the procurement information of the unlocked trophy to the external server apparatus.

A server apparatus collects trophy procurement information transmitted from multiple information processing apparatuses operated by multiple players and analyzes play trends related to trophy procurement. For example, the server apparatus may statistically derive the order in which multiple trophies are procured in one game, based on trophy procurement information sent by multiple information processing apparatuses.

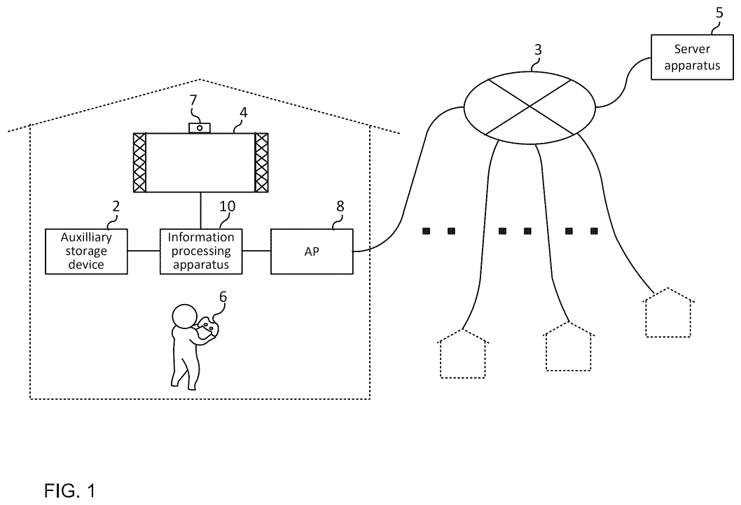

FIG. 1 illustrates an information processing system 1 according to an embodiment of the present disclosure. The information processing system 1 of the embodiment is a game system that assists the user in gameplay, and is provided with an information processing apparatus 10 operated by the user who is a player, and a server apparatus 5. An access point (hereinafter referred to as “AP”) 8 has the functions of a wireless access point and a router, and the information processing apparatus 10 connects to the AP 8 wirelessly or via a wired connection to communicably connect to the server apparatus 5 on a network 3. While FIG. 1 illustrates one user and one information processing apparatus 10, the information processing system 1 is premised on multiple the information processing apparatus 10 operated by multiple players connected to the server apparatus 5 via the network 3.

The information processing apparatus 10 is connected wirelessly or via a wired connection to an input device 6 that is operated by a user, and the input device 6 outputs information operated by the user to the information processing apparatus 10. When receiving operation information from the input apparatus 6, the information processing apparatus 10 reflects the information in processing of the system software and game software, and causes processing results to be output from an output apparatus 4. In the information processing system 1, the information processing apparatus 10 is a game apparatus (game console) that executes a game, and the input apparatus 6 may be equipment such as a game controller that supplies user operation information to the information processing apparatus 10. Note that the input device 6 may be an input interface such as a keyboard or a mouse.

An auxiliary storage device 2 is a large-capacity recording device such as an HDD (hard disk drive) or an SSD (solid state drive), and may be a built-in recording device or an external recording device that is connected to the information processing apparatus 10 via a USB (universal serial bus) or the like. The output device 4 may be a television that has a display that outputs an image and a speaker that outputs sound. The output device 4 may be connected to the information processing apparatus 10 by a wired cable, or may be connected wirelessly.

A camera 7 serving as an imaging device is provided in a vicinity of the output device 4 and captures an image of a space around the output device 4. FIG. 1 illustrates an example in which the camera 7 is mounted on a top portion of the output device 4, but such may be disposed on a side or bottom portion of the output device 4, and in any case, is disposed in a position in which an image of a user positioned in front of the output device 4 may be captured. The camera 7 may also be a stereo camera.

The server apparatus 5 provides a network service to a user of the information processing system 1. The server apparatus 5 manages network accounts (user accounts) that distinguish users, and the users sign in to the network service provided by the server apparatus 5 by using the network accounts. By signing in to the network service from the information processing apparatus 10, a user may register game save data and trophies, which are virtual prizes obtained during gameplay, in the server apparatus 5. By registering the save data and the trophies in the server apparatus 5, the save data and trophies may be synchronized even when the user uses an information processing apparatus other than the information processing apparatus 10.

The server apparatus 5 of the embodiment collects event data from multiple the information processing apparatuses 10. The server apparatus 5 has a function of statistically processing information about an activity from the collected event data and deriving an estimated play time for the activity. The server apparatus 5 also has a function of deriving an order in which multiple activities were performed from the event data of multiple players who have completed the game. By deriving the order of multiple activities performed from the start of the game until game completion, it is possible to derive a progress rate of the game currently being played and the time remaining until the game is completed and inform the user.

The server apparatus 5 of the embodiment also collects information on trophies procured by players from the information processing apparatuses 10. The server apparatus 5 has a function of analyzing play trends concerning the procurement of trophies from collected trophy procurement information. In particular, the server apparatus 5 has a function of calculating the order in which the trophies are procured.

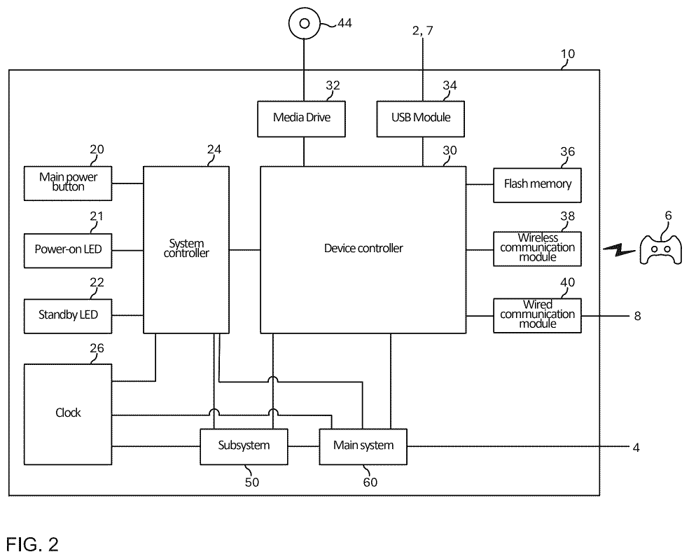

FIG. 2 illustrates a hardware configuration of the information processing apparatus 10. The information processing apparatus 10 is configured having a main power button 20, a power-on LED 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 is provided with a main CPU (central processing unit), a memory serving as a main storage device, a memory controller, a GPU (graphics processing unit), and the like. The GPU is primarily used for computational processing of a game program. The main CPU has the function of starting up the system software and executing a game program installed in the auxiliary storage device 2 in an environment provided by the system software. The subsystem 50 is provided with a sub-CPU, the memory serving as the main storage device, the memory controller, and the like, but is not provided with the GPU.

While the main CPU has the function of executing the game program installed in the auxiliary storage device 2, the sub-CPU does not have such a function. However, the sub-CPU has a function of accessing the auxiliary storage device 2 and a function of transmitting and receiving data to and from the server apparatus 5. The sub-CPU is configured having only such limited processing functions, and may therefore operate with less power consumption than the main CPU. These functions of the sub-CPU are executed when the main CPU is in a standby state.

The main power button 20 is an input unit wherein operation input from a user is performed, is provided on a front surface of a housing of the information processing apparatus 10, and is operated in order to turn on or turn off power supply to the main system 60 of the information processing apparatus 10. The power-on LED 21 lights up when the main power button 20 is turned on, and the standby LED 22 lights up when the main power button 20 is turned off. The system controller 24 detects when the main power button 20 is pressed by a user.

The clock 26 is a real-time clock that generates current date and time information and supplies such to the system controller 24, the subsystem 50, and the main system 60.

The device controller 30 is configured as an LSI (large-scale integrated circuit) that executes a transfer of information between devices, like a southbridge. As illustrated in the figure, devices such as the system controller 24, the media drive 32, the USB module 34, the flash memory 36, the wireless communication module 38, the wired communication module 40, the subsystem 50, and the main system 60 are connected to the device controller 30. The device controller 30 absorbs a difference in electrical characteristics and a gap in data transfer speeds of the various devices and controls the timing of data transfer.

The media drive 32 is a drive device that is driven by loading a ROM medium 44 on which application software such as a game and license information are recorded, and that reads out programs, data, and the like from the ROM medium 44. The ROM medium 44 is a read-only recording medium such as an optical disk, a magneto-optical disk, or a Blu-ray disk.

The USB module 34 is a module that connects to external equipment using a USB cable. The USB module 34 may be connected to the auxiliary storage device 2 and the camera 7 via a USB cable. The flash memory 36 is an auxiliary storage device that constitutes internal storage. The wireless communication module 38 wirelessly communicates with the input device 6 using a communication protocol such as a Bluetooth (registered trademark) protocol or an IEEE 802.11 protocol. The wired communication module 40 performs wired communication with external equipment and connects to the network 3 via the AP 8.

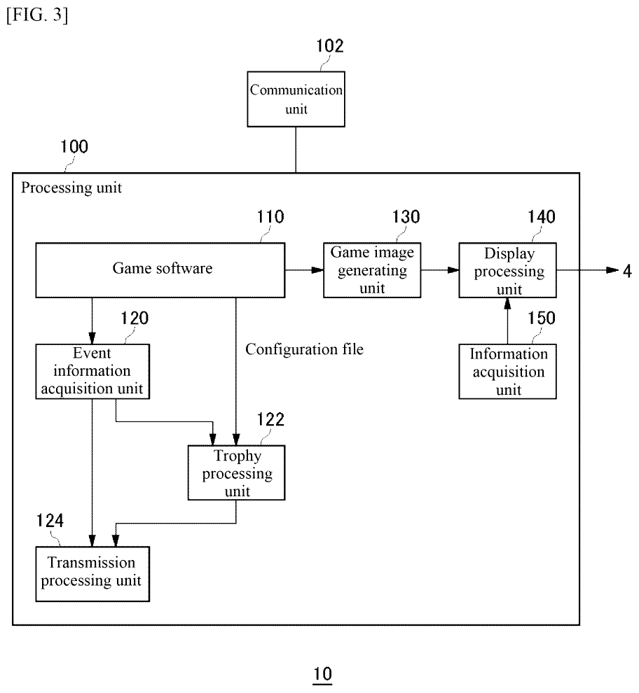

FIG. 3 illustrates functional blocks of the information processing apparatus 10. The information processing apparatus 10 is provided with a processing unit 100 and a communication unit 102. The processing unit 100 is provided with a game software 110, an event information acquisition unit 120, a trophy processing unit 122, a transmission processing unit 124, a game image generating unit 130, a display processing unit 140 and an information acquisition unit 150.

The information processing apparatus 10 is provided with a computer, and the various functions illustrated in FIG. 3 are realized by the computer executing a program. The computer is provided with, as hardware, a memory into which the program is loaded, one or more processors that execute the loaded program, an auxiliary storage device, other LSIs, and the like. The processor is configured by multiple an electronic circuit including a semiconductor integrated circuit and an LSI, and multiple electronic circuits may be mounted on one chip or may be mounted on multiple chips. The functional blocks illustrated in FIG. 3 are realized by cooperation of hardware and software, and therefore, it will be understood by those skilled in the art that these functional blocks may be realized in various forms by hardware alone, software alone, or a combination thereof.

The game software 110 includes at least the game program, image data, sound data, and a configuration file. The game program receives operation information of the input apparatus 6 from the user and performs calculation processing to move a game character in a virtual space. The game image generating unit 130 includes a GPU (graphics processing unit) that executes rendering processes and the like, and generates image data of the game. The display processing unit 140 outputs a generated game image from the output apparatus 4. Note that the processing unit 100 is provided with a game audio generating unit that generates game audio data, but illustration is omitted in FIG. 3.

When an event occurs while the game is in progress, the game program outputs event information indicating the event that has occurred. The event information acquisition unit 120 acquires the event information from the game software 110 and provides such to the trophy processing unit 122. The event information acquisition unit 120 generates event data wherein the user account, game ID, and time information (timestamp) indicating the time when the event occurred to the event information are added to the event information, and provides such to the transmission processing unit 124. Note that the game program may output event information including the game ID and/or timestamp to the event information acquisition unit 120. The transmission processing unit 124 transmits the generated event data to the server apparatus 5 via the communication unit 102.

In the game program, the start and end of the activity are coded as an event. When the activity is started while the game is in progress, the game program outputs event information indicating the occurrence of a start event of the activity, and when the activity is ended, outputs event information indicating the occurrence of an end event of the activity. A game maker may include various events in the game. For example, when a battle activity against an enemy boss is incorporated into the game, the game program outputs, at the start of the battle, event information including an activity ID that identifies the battle activity and information indicating the start of the battle activity. When the player wins the battle against the enemy boss, the game program outputs event information including the activity ID that identifies the battle activity, information indicating the end of the battle activity, and information indicating success of the activity.

The transmission processing unit 124 transmits event data relating to the activity performed by the player to the server apparatus 5 via the communication unit 102. In the information processing system 1, transmission processing of the event data is performed by all information processing apparatuses 10 connected to the server apparatus 5, and the server apparatus 5 collects event data related to various activities of various games from multiple information processing apparatuses 10. Note that there are also events other than the activity, so the transmission processing unit 124 also transmits event data unrelated to the activity to the server apparatus 5. It is preferable that, when the event information acquisition unit 120 acquires the event information from the game software 110, event data having a timestamp added is immediately generated, and transmitted to the server apparatus 5 by the transmission processing unit 124.

In order to increase the user's motivation for gameplay, the game is set with various missions for obtaining trophies. When the user completes a mission, the user is awarded a trophy corresponding to the mission. There are multiple types of trophies available in the game depending on a difficulty of the mission, with bronze, silver, gold, and platinum trophies available in order of increasing difficulty.

The configuration file included in the game software 110 describes a correspondence between the event information output from the game and the condition for unlocking the trophy. For example, the configuration file describes that a “Defeat a miniboss” event is an unlock condition for a bronze trophy. Similarly, the configuration file describes that a “Defeat a mid-boss” event is an unlock condition for a silver trophy, and a “Defeat a big boss” event is an unlock condition for a gold trophy.

The trophy processing unit 122, when provided with the event information from the event information acquisition unit 120, refers to the configuration file and performs achievement determination processing for the trophy unlock condition. When the trophy processing unit 122 determines achievement of the unlock condition, it generates obtainment information of the unlocked trophy and provides such to the transmission processing unit 124. For example, when the trophy processing unit 122 is provided with event information indicating that a mid-boss has been defeated, it determines that the unlock condition for the silver trophy has been met and generates obtainment information for the trophy. The obtainment information of the trophy includes identification information identifying the game (game ID), identification information identifying the unlocked trophy (trophy ID) and unlock time information (timestamp).

The transmission processing unit 124 transmits the generated obtainment information of the trophy to the server apparatus 5 via the communication unit 102. In the information processing system 1, transmission processing of the trophy procurement information is performed by all information processing apparatuses 10 connected to the server apparatus 5, and the server apparatus 5 collects trophy procurement information of various games from multiple information processing apparatuses 10. It is preferable that, when the trophy processing unit 122 generates the trophy procurement information, the transmission processing unit 124 immediately transmits it to the server apparatus 5.

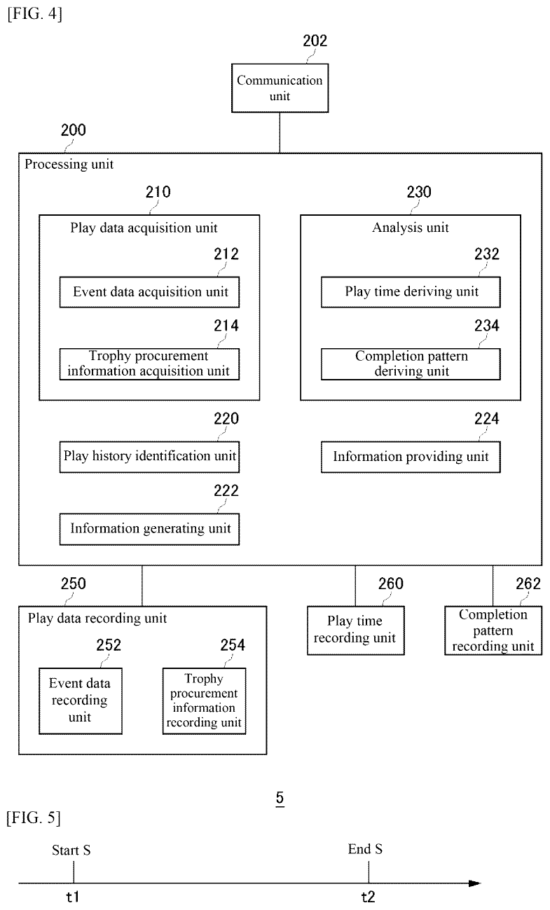

FIG. 4 illustrates functional blocks of the server apparatus 5 according to the embodiment. The server apparatus 5 includes a processing unit 200, a communication unit 202, a play data recording unit 250, a play time recording unit 260, and a completion pattern recording unit 262. The play data recording unit 250 has an event data recording unit 252 and a trophy procurement information recording unit 254. The processing unit 200 includes a play data acquisition unit 210, a play history identification unit 220, an information generating unit 222, an information providing unit 224, and an analysis unit 230. The play data acquisition unit 210 has an event data acquisition unit 212 and a trophy procurement information acquisition unit 214. The analysis unit 230 includes a play time derivation unit 232 and a completion pattern derivation unit 234.

The server apparatus 5 is provided with a computer, and the various functions illustrated in FIG. 4 are realized by the computer executing a program. The computer is provided with, as hardware, a memory into which the program is loaded, one or more processors that execute the loaded program, an auxiliary storage device, other LSIs, and the like. The processor is configured by multiple an electronic circuit including a semiconductor integrated circuit and an LSI, and multiple electronic circuits may be mounted on one chip or may be mounted on multiple chips. The functional blocks illustrated in FIG. 4 are realized by cooperation of hardware and software, and therefore, it will be understood by those skilled in the art that these functional blocks may be realized in various forms by hardware alone, software alone, or a combination thereof.

The play data acquisition unit 210 acquires various data obtained when multiple players play the game (hereinafter also referred to as “play data”), and records it in the play data recording unit 250. Play data is data generated in relation to gameplay and indicates a status, results, or the like when playing the game. The play data includes at least event data and/or trophy procurement information. The play data recording unit 250 records the play data of multiple players.

The event data acquisition unit 212 acquires event data relating to the activity performed by multiple players from multiple information processing apparatuses 10, and records such in the event data recording unit 252. The event data recording unit 252 records the event data for each game title, linked to the player's network account. As described above, the event data includes at least the game ID, the activity ID, information indicating the start or end of the activity, and the timestamp. The event data acquisition unit 212 may acquire event data that is not related to an activity and record it in the event data recording unit 252.

The trophy procurement information acquisition unit 214 acquires information on the trophy obtained by multiple players from multiple information processing apparatuses 10 and records such in the trophy procurement information recording unit 254. The trophy procurement information recording unit 254 records the trophy procurement information for each game title, linked to the player's network account. As already described, the trophy procurement information contains at least a game ID, a trophy ID, and a timestamp.

The following describes the process in which the analysis unit 230 analyzes past play data of multiple players of a game X to derive information about play units such as activities and trophies.

### <Activity Play Time Derivation Process>

The play time derivation unit 232 acquires the play time of the activity of multiple players from event data including start event information of the activity (start event data) and event data including end event information of the activity (end event data) recorded in the event data recording unit 252. The play time of the activity is calculated based on the timestamp included in the start event data and the timestamp included in the end event data.

FIG. 5 is a diagram for describing a method for calculating play time. FIG. 5 illustrates a start event and an end event of an activity S by one player, and specifically, “S start” indicates the start event of the activity S, and “S end” indicates the end event of the activity S. The start event data includes a start time t1 of the activity S, the end event data includes the end time t2 of activity S, and the play time derivation unit 232 calculates the play time of activity S by the player as (t2−t1). The play time derivation unit 232 links the calculated play time of the activity S to the player's network account and records such in the play time recording unit 260 together with the game ID and activity ID. Similarly, the play time derivation unit 232 derives the play time of the activity S by other players and links it to the player's network account and records such in the play time recording unit 260 together with the game ID and activity ID.

The play time derivation unit 232 averages the play times derived for all players for the activity S of the game X to derive an average play time for the activity S and records this in the play time recording unit 260. The play time derivation unit 232 also derives average play times of other activities in the game X and records the average play times of all activities in the game X in the play time recording unit 260. The average play time is used as an estimated play time of a user who has not yet performed an activity.

The play time derivation unit 232 may derive the estimated play time according to the user's game skill (class) instead of the average play time. Patent document 1 discloses art in which players are assigned to any of multiple classes according to skill values of the players, and a median play time of a number of players in each class is used as a representative value of the play time for each class. The play time derivation unit 232 may derive the representative value of the play time for each class using the art disclosed in patent document 1 and record the value in the play time recording unit 260. The representative value of each class is used as an estimated play time of a user who has not yet performed an activity.

As described above, the play time recording unit 260 records the estimated play time of the activity. The representative value of the play time for each class is derived based on the user's game skill and is therefore considered to indicate a more accurate estimated time than the average play time.

### <Activity Implementation Order Derivation Process>

The completion pattern derivation unit 234 analyzes past event data of multiple players recorded in the event data recording unit 252 and derives a play pattern indicating the order in which a player who has played the game to the end (completed the game) played multiple play units. In the embodiments, this play pattern is called a “completion pattern.” Hereinafter, the completion pattern derivation unit 234 derives a completion pattern that indicates the order in which multiple activities are played by the game completion. As will be described later, the completion pattern derivation unit 234 may derive a completion pattern that indicates the order in which a number of trophies are obtained by the game completion.

### (Identification of Activity Performed at Beginning of Game)

The completion pattern derivation unit 234 identifies an activity that the player performs first in the game X (hereinafter also referred to as an “initial activity”). The completion pattern derivation unit 234 may identify the activity that was first performed by the most players as the initial activity.

### (Identification of Activity Indicating Game Completion)

Next, the completion pattern derivation unit 234 identifies an activity that indicates game completion (story completion). The completion pattern derivation unit 234 may identify an activity to be performed when the game is completed according to the following criteria.

### (Criterion 1): An Activity Last Performed by a Player Who has Completed the Game X is Identified as an Activity Indicating Game Completion (Final Activity).

First, the completion pattern derivation unit 234 identifies players who have stopped playing the game X altogether (players who have finished the game) from the player's event data. Specifically, the completion pattern derivation unit 234 identifies players who have not played game X for a predetermined period of time (for example, three months). The completion pattern derivation unit 234 extracts activities last performed by the players who have finished the game and identifies an activity last performed by the most players who have finished the game as the final activity. Note that players who have stopped playing the game X altogether include not only players who have completed the game X but also players who have quit the game X midway (dropout players), but it is thought that there is little or no commonality in the last activities performed by dropout players. Therefore, the completion pattern derivation unit 234 may identify the activity that was last performed by the most players that finished the game as the final activity.

### (Criterion 2): Identify the Final Activity Based on Attribute Information of the Activity.

The game maker adds attribute information such as a name and description to the activity. Therefore, the completion pattern derivation unit 234 may analyze attribute information of the activities of the game X to identify the final activity. For example, when the name of a given activity is “Defeat the final boss” or the description is “Defeat this boss to complete the game,” the completion pattern derivation unit 234 may decipher the meaning of the attribute information and identify this activity as the final activity.

Furthermore, when the game X is made up of multiple chapters, the completion pattern derivation unit 234 analyzes the attribute information of the activity and identifies the chapter having the highest number as the final chapter. For example, when it is determined that Chapter 9 is the final chapter, the name of the activity is “Complete Chapter 9,” or the description is “Complete Chapter 9,” the completion pattern derivation unit 234 may decipher the meaning of the attribute information and identify this activity as the final activity.

The completion pattern derivation unit 234 may have a function of deriving multiple final activities. For example, when the game X has multiple ways of completing the game, such as a good ending and a bad ending, the completion pattern derivation unit 234 preferably derives multiple final activities. With regard to criterion 1, the completion pattern derivation unit 234 can identify multiple final activities by identifying the final activity performed by a predetermined percentage (for example, 25%) or more of the players who have finished the game as the final activity. concerning criterion 2, when the descriptions of a plurality activities state that they are conditions for completing the game, then this plurality of activities may be identified as final activities.

### (Identification of Activity Performed by Game Completion)

The completion pattern derivation unit 234 identifies an activity history common to many players based on the event data of the multiple players, and derives the order of multiple activities that need to be performed by the game completion. In games where the story progresses according to scenarios, such as RPGs, although there are some branching paths, a number of predetermined activities are generally performed in a set order. The completion pattern derivation unit 234 investigates story progression (activity history) common to many players, identifies an order of multiple activities to be performed by game completion, and derives a completion pattern.

The completion pattern includes at least a play pattern that indicates the order in which activities that are necessary to complete the game are to be performed. Generally, a story often branches, so it is preferable that the completion pattern derivation unit 234 derives completion patterns for routes branching from the main pattern in addition to the completion pattern for the main activity.

The completion pattern derivation unit 234 may identify the order in which the activities are performed based on the attribute information of the activities. For example, when the name of a given activity “About to defeat the final boss,” or the description is “Once you get through this, you'll face the final boss,” the completion pattern derivation unit 234 may decipher the meaning of the attribute information and identify that this activity is the activity that is performed immediately before the final activity. Furthermore, when the game X is composed of multiple chapters and the final chapter is Chapter 9, the completion pattern derivation unit 234 may determine that the activities of Chapters 1 to 8 are to be performed in that order.

In addition, when a flag indicating that an activity must be performed is set for the activity and the condition for completing the game is to perform all activities for which the flag is set, the completion pattern derivation unit 234 may use the flag to extract multiple activities that must be performed and determine the order in which they are to be performed.

As described above, the completion pattern derivation unit 234 statistically processes past event data from a large number of players to derive a completion pattern that indicates the order in which multiple activities are performed by the game completion. The completion pattern derivation unit 234 records the derived completion pattern in the completion pattern recording unit 262. This statistical processing may be performed periodically. By analyzing past event data from a large number of players, the completion pattern derivation unit 234 can improve the accuracy of the completion pattern.

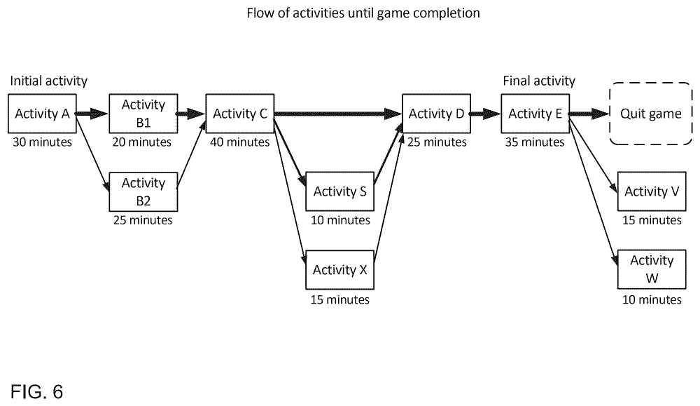

FIG. 6 illustrates an example of a completion pattern for the game X. The completion pattern indicates the order in which activities are performed from the initial activity to the final activity. In this example, the activity S is identified as the initial activity, and an activity E is identified as the final activity. Arrows connecting activities indicate a direction of transition between the activities, and thickness of the arrows reflects a number of players, with the number of players being greater the thicker the arrow is. The estimated play time for the activity recorded in the play time recording unit 260 is written below each activity.

The completion pattern derivation unit 234 analyzes past event data recorded in the event data recording unit 252 and identifies the order of activities required from the start of play to game completion. In this example, the player performs the activity S, and then performs an activity B1 or an activity B2. As indicated by the thickness of the arrows, a large number of players have performed the activity B1, and a small number of players have performed the activity B2.

The players perform an activity C after performing the activity B1 or the activity B2. Then, about 50% of the players perform an activity D, about 40% of players perform the activity S before performing activity D, and about 10% of players perform an activity X before performing activity D. After performing the activity D, the player performs the activity E and completes the game. In this example, there are players who perform an activity V and an activity W after completing the game.

In this completion pattern, an order of the activity S, the activity B1, the activity C, the activity D, and the activity E indicates a main pattern performed by the most players. The activity B1 and the activity B2 are performed optionally. Therefore, a pattern of the activity S, the activity B1, the activity C, the activity D, and the activity E and a pattern of the activity S, the activity B2, the activity C, the activity D, and the activity E constitute completion patterns required to complete the game. The activity S and the activity X are not essential activities for completing the game, but the activity S is considered to be an activity highly worth playing because it is performed by many players.

### <Play Support Information Display Function>

Next, a function of the server apparatus 5 to present play support information will be described.

While the user is playing the game, the event data acquisition unit 212 acquires event data from the information processing apparatus 10 in real time and records it in the event data recording unit 252. The play history identification unit 220 reads activity history of a user currently playing the game from the event data recording unit 252 in real time.

The information generating unit 222 generates information concerning game completion from the most recent activity history of the user. Specifically, the information generating unit 222 generates information about game completion of the user from the user's activity history based on the completion pattern recorded in the completion pattern recording unit 262.

### (Deriving Progress Rate of Gameplay)

The information generating unit 222 may generate information indicating progress of gameplay as information concerning game completion. The information generating unit 222 generates information indicating the progress of gameplay using the following (Formula 1).

$$\begin{matrix}[ Math . 1 ] & \\ ( Progress rate of gameplay ) = \frac{\begin{matrix}\text{"Total estimated play time of activites required to} \\ complete the game performed up to now \text{"}\end{matrix}}{\begin{matrix}\text{"Total estimated play time of activites required} \\ from the start of the game to completing the game \text{"}\end{matrix}} & ( Formula 1 )\end{matrix}$$

This will be explained based on the completion pattern illustrated in FIG. 6. When the user finishes the activity C, the play history identification unit 220 identifies a play history indicating that the user has performed the activity S, the activity B1, and the activity C. The information generating unit 222 derives a progress rate of gameplay using (Formula 1).

A “total estimated play time of activities required to complete the game performed up to now” is calculated as a total estimated play time of the activity S, the activity B1, and the activity C. The information generating unit 222 references the play time recording unit 260, which records the estimated play times for the activities, and calculates a total as “90 minutes” by adding up the estimated play time for the activity S (30 minutes), the estimated play time for the activity B1 (20 minutes), and the estimated play time for the activity C (40 minutes).

A “total estimated play time of activities required from the start of the game to completing the game” is calculated as the sum of the “total estimated play time of activities required to complete the game that have been performed up to now” and a “total estimated play time of activities in the main completion pattern that will be performed from now on.” The information generating unit 222 references the play time recording unit 260 and calculates a total as “150 minutes” by adding up the estimated play time of the activity A (30 minutes), the estimated play time of the activity B1 (20 minutes), the estimated play time of the activity C (40 minutes), the estimated play time of the activity D (25 minutes), and the estimated play time of the activity E (35 minutes).

Therefore, the information generating unit 222 calculates from (Formula 1) that the progress of gameplay is 60% (=90 minutes/150 minutes). In this way, by using the estimated play time, the information generating unit 222 can determine a time-based progress rate that matches the user's perception.

### (Derivation of Estimated Time to Game Completion)

The information generating unit 222 may derive an estimated time until the game is completed as information relating to the game being completed. The information generating unit 222 uses (Formula 2) to derive the estimated time until the game is completed.

$$\begin{matrix}[ Math . 2 ] & \\ ( \begin{matrix}Time until game \\ completion\end{matrix} ) = ( \begin{matrix}Total estimated play time of \\ activites required from the \\ start of the game to \\ completing the game\end{matrix} - \begin{matrix}Total estimated play time of \\ activites required to \\ complete the game \\ performed up to now\end{matrix} ) \times α & ( Formula 2 )\end{matrix}$$

The “total of estimated play times of activities required for game completing performed up to the present” is calculated as a total of the estimated play times of the activity A, the activity B1, and the activity C, and an information generating unit 222 references the play time recording unit 260 to calculate “90 minutes.”

The “total estimated play time of activities required from the start of the game to completing the game” is calculated as the sum of the “total estimated play time of activities required to complete the game that have been performed up to now” and the “total estimated play time of activities in the main completion pattern that will be performed from now on,” and the information generating unit 222 references to the play time recording unit 260 and calculates “150 minutes.”

In (Formula 2), α is an adjustment coefficient, which has a value of 1 or more. The interval between the end of a given activity and the start of another activity varies depending on the game, with some games having short intervals between activities and others having long intervals between activities. When a ratio of play time for an activity to play time for something other than the activity in the total play time until game completion is 1:N, the adjustment coefficient α may be derived as (1+N).

When the ratio of the play time for the activity to the play time for something other than the activity is 1:1, the adjustment coefficient α is 2. Therefore, the information generating unit 222 calculates from (Formula 2) that the time until game completion is 120 minutes (=(150 minutes−90 minutes)×2). The information generating unit 222 can calculate the estimated time required to complete the game by using the estimated play time of the activity.

In this way, the information generating unit 222 generates information concerning the user's completion of the game. The information providing unit 224 provides the information generated by the information generating unit 222 to the information processing apparatus 10. The information providing unit 224 may provide the information at any timing.

In the information processing apparatus 10, the information acquisition unit 150 acquires information relating to game completion from the server apparatus 5. The display processing unit 140 displays the information acquired by the information acquisition unit 150 on the output device 4.

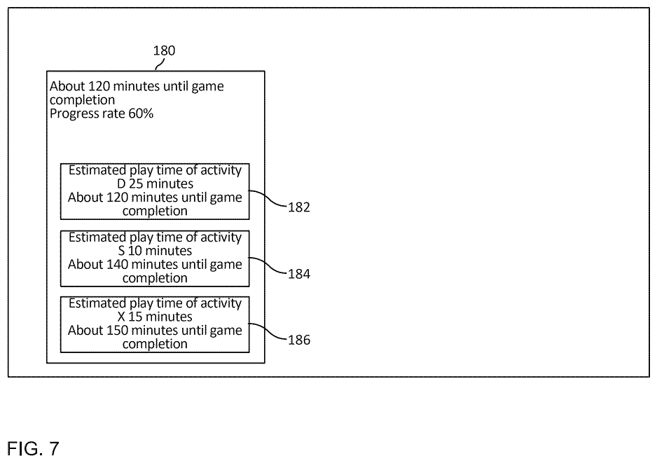

FIG. 7 shows an example of a system screen displayed on the output device 4. The display processing unit 140 generates a system image 180 from the information acquired by the information acquisition unit 150 and displays it on an output device 4. The system image 180 displays an estimated time (120 minutes) until the game X is completed and the progress rate (60%) of the game X. The system image 180 may be superimposed on the game screen of the game X currently being played. The system image 180 displays a number of activities that can be performed next.

Information on the activity D is displayed in a display area 182. In this example, the estimated play time for the activity D (25 minutes) and the estimated time to complete the game when the activity D is played (120 minutes) are displayed.

Information on the activity S is displayed in a display area 184. In this example, the estimated play time of the activity S (10 minutes) and the estimated time to complete the game when playing the activity S (140 minutes) are displayed.

Information on the activity X is displayed in a display area 186. In this example, the estimated time of the activity X (15 minutes) and the estimated time to complete the game when playing the activity X (150 minutes) are displayed.

The system image 180 displayed in card format is a GUI (Graphical User Interface), and when the user selects any the display areas 182, 184, and 186, an activity corresponding to the selected display area starts. As described above, according to the embodiment, the user can know the progress of the gameplay and the estimated time until game completion by receiving information about the completion of the game from the server apparatus 5. Furthermore, for each activity, the user is presented with an estimated time to complete the game if the user performs the activity, allowing the user to decide which activity to perform.

The above describes how the server apparatus 5 derives a completion pattern that indicates the order of multiple activities, and generates information related to game completion using this completion pattern. The server apparatus 5 may derive a completion pattern which indicates the order in which the trophies are obtained by the game completion and may use this completion pattern to generate information relating to game completion.

The completion pattern derivation unit 234 analyzes the trophy procurement information of multiple players recorded in the trophy procurement information recording unit 254 and derives a play pattern showing in what order the players who played the game to the end (completed the game) procured multiple trophies.

### (Identification of Trophy Procured at Beginning of Game)

The completion pattern derivation unit 234 identifies a trophy that the player will first procure in the game X (hereinafter also referred to as an “initial trophy”). The completion pattern derivation unit 234 may identify the trophy that is first procured by the most players as the initial trophy.

### (Identification of Trophy Indicating Game Completion)

Next, the completion pattern derivation unit 234 identifies a trophy that indicates game completion (story completion). As described in relation to activities, the completion pattern derivation unit 234 may identify a trophy to be procured when the game is completed according to criterion 1 or criterion 2.

### (Identification of Trophy Procured by Game Completion)

The completion pattern derivation unit 234 determines the trophy procurement history common to many players based on the trophy procurement information of multiple players and derives the order in which multiple trophies must be procured before the game is completed. The completion pattern derivation unit 234 investigates the story progress common to many players, identifies the order of multiple trophies to be procured by game completion, and derives a completion pattern.

As described above, the completion pattern derivation unit 234 derives a completion pattern indicating the order of multiple trophies procured by the game completion by statistically processing past trophy procurement information from a large number of players. The completion pattern derivation unit 234 records the derived completion pattern in the completion pattern recording unit 262. The information generating unit 222 may generate information about game completion of a player from the play data of the user based on the completion pattern.

By deriving a completion pattern for trophies, the information generator 222 can know the trophies required to complete the game. Therefore, the information generating unit 222 may generate play support information that recommends the procurement of trophies necessary for completing the game, and the information providing unit 224 may provide this to the user. In particular, when it is determined that the user is a player who prioritizes completing the game without taking detours, the information providing unit 224 may generate play support information that recommends trophies or activities that are directly linked to completing the game.

Note that whether a player prioritizes completing the game may be determined from the user's play history. The play history identification unit 220 may identify the user's activity history and trophy procurement history, and when the activity history and trophy procurement history conform to a completion pattern, determine that the player prioritizes completing the game.

After the user has completed the game, the information generating unit 222 may generate play support information that recommends activities and trophies that can be played even after the game has been completed. Referring to FIG. 6, an activity V and an activity W are activities that are continued even after the game has been completed, and the information generating unit 222 generates play support information that recommends the performance of these activities, and the information providing unit 224 provides this to the user, thereby enabling the user to continue playing the game even after completing it.

The above is a description of the present invention based on an embodiment. This embodiment is an example, and will be understood by those having ordinary skill in the art that various variations are possible in the combination of their respective constituent elements and respective processing processes, and that such variations are also within the scope of the present disclosure. In the embodiment, activities and trophies are given as examples of play units, but play units may also be made up of stages that do not have activities or trophies, quests, missions, tournaments, sessions, or the like.

The server apparatus 5 may analyze the activity history and the trophy procurement history to derive information such as distribution of time players take to complete the game, distribution of time players take to complete trophies, and the number of players who continue playing after completing the game, and present this information to the user.

### INDUSTRIAL APPLICABILITY

The present disclosure relates to art for providing information about a game to a user.

### DESCRIPTION OF REFERENCE NUMERALS

1 . . . information processing system, 5 . . . server apparatus, 10 . . . information processing apparatus, 100 . . . processing unit, 102 . . . communication unit, 110 . . . game software, 120 . . . event information acquisition unit, 122 . . . trophy processing unit, 124 . . . transmission processing unit, 130 . . . game image generating unit, 140 . . . display processing unit, 150 . . . goal information acquisition unit, 200 . . . processing unit, 202 . . . communication unit, 210 . . . play data acquisition unit, 212 . . . event data acquisition unit, 214 . . . trophy procurement information acquisition unit, 220 . . . play history identification unit, 222 . . . information generating unit, 224 . . . information providing unit, 230 . . . analysis unit, 232 . . . play time derivation unit, 234 . . . completion pattern derivation unit, 250 . . . play data recording unit, 252 . . . event data recording unit, 254 . . . trophy procurement information recording unit, 260 . . . play time recording unit, 262 . . . completion pattern recording unit.

What is claimed is:

1. A server apparatus comprising:
one or more processors having hardware, configured to:
acquire play data of a user of a game;
generate information about game completion of the user from play data of the user based on a completion pattern indicating an order of multiple play units to be performed by the game completion; and
provide the user with the information about the game completion.

2. The server apparatus according to claim 1, wherein the one or more processors are configured to derive an estimated time for the game completion by the user.

3. The server apparatus according to claim 1, wherein the one or more processors are configured to derive information indicating gameplay progress of the user.

4. The server apparatus according to claim 1, further comprising a recording apparatus that is configured to record an estimated play time of each of the multiple play units, wherein the one or more processors are configured to generate the information about the game completion using estimated play times for the multiple play units included in the completion pattern.

5. A server apparatus, comprising:
a recording apparatus configured to record past play data of multiple players; and
one or more processors having hardware, configured to analyze the past play data of the multiple players to derive a completion pattern indicating an order of multiple play units to be performed by game completion.

6. The server apparatus according to claim 5, wherein the one or more processors are configured to derive a completion pattern indicating an order of essential multiple play units among the multiple play units to be performed before the game completion.

7. The server apparatus according to claim 5, wherein the one or more processors are configured to analyze play data of players who have completed the game and derive the completion pattern based on the analysis.

8. The server apparatus according to claim 7, wherein the one or more processors are configured to analyze play data of players who have played the game for equal to or less than a predetermined period of time to derive the completion pattern.

9. The server apparatus according to claim 5, wherein, the one or more processors are configured to identify a final play unit performed at the game completion.

10. An information processing apparatus comprising:
one or more processors having hardware, configured to:
acquire information about game completion related to a completion pattern indicating an order of multiple play units to be performed by the game completion; and
display an estimated time until the game completion.

11. The information processing apparatus according to claim 10, wherein the one or more processors are configured to display a progress rate of the game based on an estimated play time.

12. A method for providing information to a user, the method comprising:
acquiring play data of a user of a game;
generating information about game completion of the user from the play data of the user based on a completion pattern indicating an order of multiple play units to be performed by the game completion; and
providing the user with the information about the game completion.
